(19) United States
(12) Patent Application Publication
(10) Pub. No.: US 2003/0195925 A1
(43) Pub. Date: Oct. 16, 2003

(54) Mobile information unit, service downloading server and service downloading system

(75) Inventors: Kazuma Kaneko, Tokyo (JP); Yoshihiko Utsui, Tokyo (JP); Mitsuo Shimotani, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/265,606

(22) Filed: Oct. 8, 2002

(30) Foreign Application Priority Data
Apr. 15, 2002 (JP) 2002-112515

(51) Int. Cl. G06F 15/16

(52) U.S. Cl. 709/203

(57) ABSTRACT

A request for getting a service is sent to a service downloading server, from which a service program which offers the service is received and executed.

### BACKGROUND OF THE INVENTION

1. Field of the Invention

This invention is related to a mobile information unit, a service downloading server, and a service downloading system for offering a service requested by a user.

2. Description of the Related Art

As a conventional service downloading system, there is, for instance, the one that includes a dedicated vehicle-mounted information unit integrated with a car navigation unit, an information downloading center for downloading traffic information, and a communication line interconnecting the vehicle-mounted information unit and the information downloading center.

That is, in the conventional service downloading system, when the user operates the vehicle-mounted information unit to send a request for getting traffic information to the information downloading center, the information downloading center downloads traffic information to the vehicle-mounted information unit, which displays the traffic information.

Further, the traffic information provided by the information downloading center is graphical data in which, for instance, traffic jam information is padded in map data, and it is updated to the latest information on occasion.

Such service downloading system is found, for instance, in “Introduction of Mazda Telematics” in Mazda Technical Journal No. 19 (2001), pp. 28-32 (authors: Hiroshi Ohmura, four others).

The conventional service downloading system thus configured as described above allows the vehicle-mounted information unit to collect and display traffic information from the information downloading center if the vehicle-mounted information unit sends a request for getting traffic information to the information downloading center. However, since traffic information is by nature successively updated as circumstances demand, it needs to collect the latest traffic information from the information downloading center each time the user wishes to display traffic information, but, traffic information is immense graphical data, so the traffic between the vehicle-mounted information unit and the information downloading center became huge.

### SUMMARY OF THE INVENTION

The present invention has been made to solve the above problem, and an object there of is to provide a mobile information unit, a service downloading server, and service downloading system which can offer a service requested by a user without inviting increased traffic.

The mobile information unit according to the present invention includes service requesting means for transmitting a request for getting a service selected by service selecting means to the service downloading server, and receiving a service program which offers the particular service from the service downloading server, thereby executing the service program.

Further, the service downloading server according to the present invention, upon receipt of a request for getting a service shown in a service list from a mobile information unit, downloads a service program which offers the service to the mobile information unit.

Furthermore, the service downloading system according to the present invention includes a mobile information unit which transmits a request for getting a service to a service downloading server, receives a service program which offers the service from the service downloading server, and executes the service program.

Accordingly, according to the present invention, a service requested by a user can be rendered without incurring increased traffic.

### BRIEF DESCRIPTION OF THE DRAWINGS

FIG. 1 is a block diagram showing the service downloading system according to a first embodiment of the present invention;

FIG. 2 is a software block diagram showing the software configuration of the service downloading system according to a first embodiment;

FIG. 3 is a flowchart showing the procedures of the service downloading system according to a first embodiment;

FIG. 4 is an explanatory diagram showing a service management screen image;

FIG. 5 is an explanatory diagram showing a service list;

FIG. 6 is an explanatory diagram showing a service selection screen image;

FIG. 7 is an explanatory diagram showing a screen image indicating that the Osaka Station parking lot information service is in execution;

FIG. 8 is an explanatory diagram showing a screen image of the Osaka Station parking lot information service;

FIG. 9 is an explanatory diagram showing a service management screen image;

FIG. 10 is an explanatory diagram showing the service list hierarchized by category;

FIG. 11 is an explanatory diagram showing an example of the service selection screen image;

FIG. 12 is an explanatory diagram showing a service list containing therein information on the areas within which services can be available;

FIG. 13 is a schematic diagram showing the relationship between the vehicle position and the service area;

FIG. 14 is an explanatory diagram showing an example of the service selection screen image;

FIG. 15 is an explanatory diagram showing a service list containing therein service areas and the URLs of the local service downloading servers in those areas;

FIG. 16 is a block diagram showing the service downloading system according to a fifth embodiment of the present invention;

FIG. 17 is a software block diagram showing the software configuration of the service downloading system according to a fifth embodiment;

FIG. 18 is a schematic diagram for explaining the method of implementing a simple navigation capability by superposing a vehicle image which represents the position and direction of a vehicle on a background map image showing a map forming the background;

FIG. 19 is an explanatory diagram showing previously created vehicle images;

FIG. 20 is a flowchart showing the procedures of the simple navigation service program;

FIG. 21 is a flowchart showing the procedures of the simple navigation service program; and

FIG. 22 is an explanatory diagram showing an example in which four adjacent background map images are displayed overlapped with each other.

### DETAILED DESCRIPTION OF THE PREFERRED EMBODIMENTS

Now, the preferred embodiments of the present invention will be described with reference to the attached drawings.

### First Embodiment

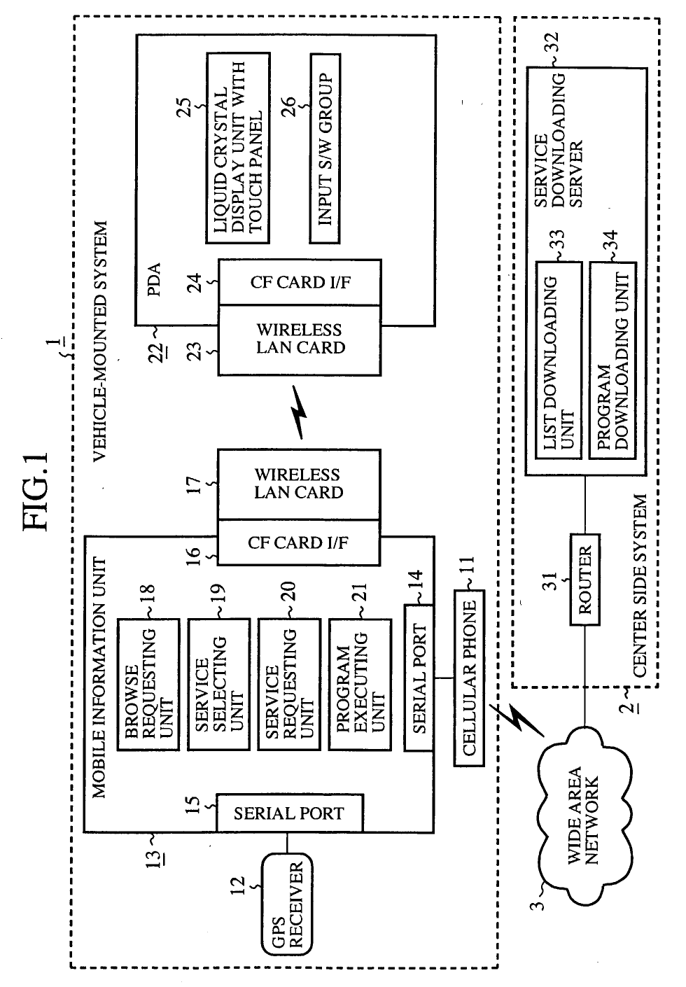

FIG. 1 is a block diagram showing the service downloading system according to the first embodiment of the present invention.

Referring to FIG. 1, reference numeral 1 denotes a vehicle-mounted system placed in the inside of a vehicle or the like, reference numeral 2 a center side system placed in a fixed building, reference numeral 3 a wide area network such as a mobile phone network for connecting the vehicle-mounted system 1 and the center side system 2, and reference numeral 11 a mobile phone for performing data exchange with the center side system 2. However, a voice telephone call is not mandatory if it is able to perform data communication. Further, the mobile phone 11 may be replaced by a PHS (Personal Handyphone System) or the like.

Reference numeral 12 denotes a GPS receiver for receiving radio waves transmitted from GPS (Global Positioning System) satellites and for calculating the vehicle position, which are Earth-orbiting artificial satellites, reference numeral 13 a mobile information unit including therein CPU (Central Processing Unit), RAM (Random Access Memory) and ROM (Read Only Memory), interface circuits for peripheral devices, etc., reference numeral 14 a serial port for connecting the mobile phone 11, reference numeral 15 a serial port for connecting the GPS receiver 12, reference numeral 16 a CF (Compact Flush) card I/F (Interface) for connecting a LAN card 17, and reference numeral 17 a wireless LAN (Local Area Network) card for performing data exchange with a PDA (Personal Digital Assistance) 22, and the wireless communication standards such as IEEE802.11.b or Bluetooth. However, as to the communication between the mobile information unit 13 and the PDA 22, it needs not necessarily be wireless, so communication may be performed through a wire.

Reference numeral 18 denotes a browse requesting unit (browse requesting means) for transmitting a browse request for getting services to the service downloading server 32, and receiving from the service downloading server 32 a service list showing available services, reference numeral 19 a service selecting unit (service selecting means) for selecting any service among the services shown in the service list received by the browse requesting unit 18, reference numeral 20 a service requesting unit (service requesting means) for transmitting a request for getting the service selected by the service selecting unit 19 to the service downloading server 32, and receiving from the service downloading server 32 a service program which offers the service, and reference numeral 21 a program executing unit (program executing means) for executing the service program received by the service requesting unit 20.

Reference numeral 22 denotes a PDA (external information unit) for accepting the user operation, and displaying the executed result of the program executing unit 21 and the like, reference numeral 23 a wireless LAN card for performing data exchange with the mobile information unit 13, reference numeral 24 a CF card I/F for connecting the wireless LAN card 23, reference numeral 25 a liquid crystal display with a touch panel, reference numeral 26 an input S/W group consisting of a plurality of input switches.

Reference numeral 31 denotes a router for performing the routing control between the service downloading server 32 and the wide area network 3, or the like, reference numeral 32 a service downloading server for downloading a service list and a service program, reference numeral 33 a list downloading unit (list downloading means) for downloading a service list showing available services to the mobile information unit 13 when receiving a browse request for getting available services from the mobile information unit 13, and reference numeral 34 a program downloading unit (program downloading means) for downloading a service program which offers a service shown in the service list to the mobile information unit 13 when receiving a request for getting the service from the mobile information unit 13.

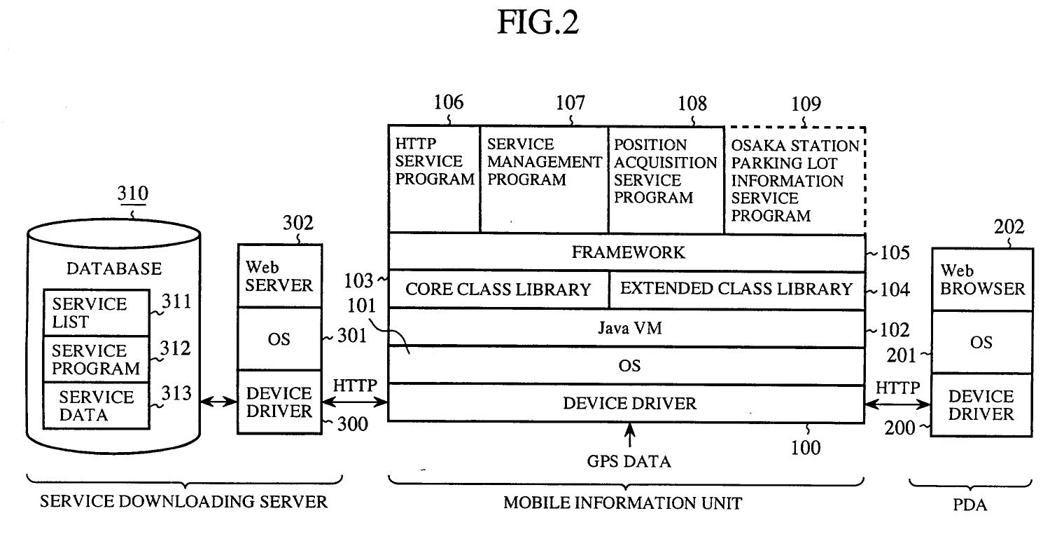

FIG. 2 is a software block diagram showing the software configuration of the service downloading system according to the first embodiment.

Referring to FIG. 2, reference numeral 100 denotes a device driver for controlling the hardware of the mobile information unit 13, reference numeral 101 an OS (Operating System) which is dedicated to control over all the software of the mobile information unit 13, reference numeral 102 a Java VM (Virtual Machine) providing the execution environment for programs described by a Java language, reference numeral 103 a core class library providing the basic capability of the Java language, reference numeral 104 an extended class library providing an extended capability of the Java language (for instance, a capability of enabling the use of the serial ports 14 and 15 of the mobile information unit 13), and reference numeral 105 a framework for controlling the dynamic start, stop, add, delete and the like of a program described by the Java language.

Reference numeral 106 denotes a HTTP (Hyper Text Transfer Protocol) service program, reference numeral 107 a service management program for supporting the start, stop, add, delete and the like of a service by the user, reference numeral 108 a position acquisition service program for getting the position of a vehicle, and providing the vehicle position to another service program, and reference numeral 109 an example of the service program got from the service downloading server 32, which is an Osaka Station parking lot information service program for notifying the user of the location, full/empty status and the like of the Osaka Station parking lot. In addition, the programs in the layer higher than the framework 105 are described by the Java language.

Reference numeral 200 denotes a device driver for controlling the hardware of the PDA 22, reference numeral 201 an OS which is dedicated to control over all the software of the PDA 22, and reference numeral 202 an Web browser for interpreting and displaying a document described by a markup language such as HTML (Hyper Text Markup Language). Here, for communication between the mobile information unit 13 and the PDA 22, HTTP is used.

Reference numeral 300 denotes a device driver for controlling the hardware of the service downloading server 32, reference numeral 301 an OS which is dedicated to control over all the software of the service downloading server 32, reference numeral 302 an Web server for responding to a request by HTTP from the mobile information unit 13, reference numeral 310 the database of the service downloading server 32, reference numeral 311 a service list showing available services to a user, reference numeral 312 a service program described by a Java language (for instance, Osaka Station parking lot information service program), and reference numeral 313 service data such as a file in which information necessary for the operation of the service program 312 is stored.

Further, the HTTP service program 106 and the service management program 107 constitute the browse requesting means, service selecting means, and service requesting means, and the Java VM 102, core class library 103, extended class library 104, and framework 105 constitute the program executing means.

Furthermore, the Web server constitutes the list downloading means and program downloading means.

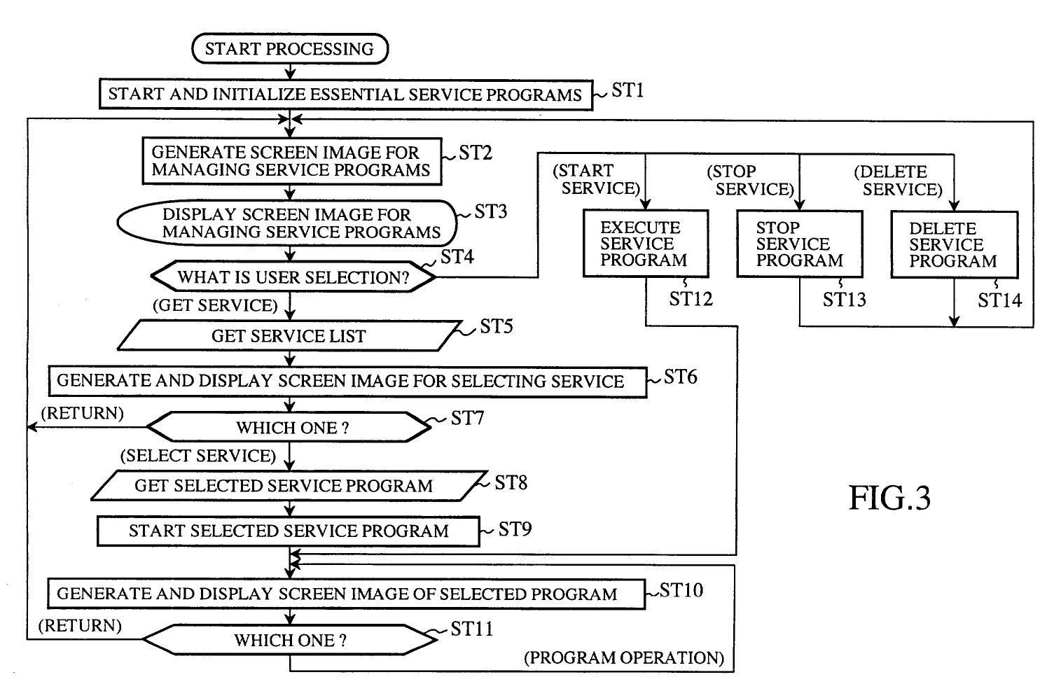

FIG. 3 is a flowchart showing the procedures of the service downloading system according to the first embodiment.

Now, the operation of the service downloading system of the first embodiment will be described.

At step ST1, when power is supplied by the ignition of the vehicle, the OS 101 of the mobile information unit 13 boots.

The OS 101 initializes the device driver 100 to enable each part of the hardware of the mobile information unit 13 to be controlled from software, and activates the Java VM 102.

Then, the Java VM 102 loads the core class library 103 and the extended class library 104 onto the RAM, bringing the program described by the Java language to be operable.

The OS 101 outputs a request for starting up the framework 105 to the Java VM 102 after the Java VM 102 has activated as described above.

When the Java VM 102 initiates the framework 105, the framework 105 executes the HTTP service program 106, the service management program 107, and the position acquisition service program 108, which are essential services.

These programs perform their own initialization routines when initiated. However, for convenience of explanation, it is assumed that the Osaka Station parking lot service program 109 does not exist at this point, and added later by the user's operation.

Also in the PDA 22, the OS 201, device driver 200, and Web browser 202 are started and initialized in this order. After such procedures are completed, the process proceeds to step ST2.

At step ST2, the user invokes the service management program 107 by operating the Web browser 202 of the PDA 22.

Specifically, the URL (Uniform Resource Locator) for the Web browser 202 is inputted like “http://mobile-host/service-manager”. In the above URL, “10.140.209.245” is the IP (Internet Protocol) address of the mobile information unit 13, and “/service-manager” is the alias assigned to the service management program 107 on the mobile information unit 13.

Further, the Web browser 202 sends a GET request for HTTP to the HTTP service program 106 of the mobile information unit 13.

The HTTP service program 106 having an Web server capability interprets “/service-manager” contained in the GET request sent from the Web browser 202, and instructs the service management program 107 to respond to the GET request.

That is, the service management program 107 is a servlet for responding to the GET request on the Web server, and the HTTP service program 106 invokes the doGet ( ) method of the service management program 107. Here, the communication procedure by HTTP is similar to the procedure that is typically used in the Internet.

In the doGet ( ) method, the service management program 107 inquires the framework 105 about service programs existing on the framework 105 as well as the statuses such as start, stop, and the like thereof. In response to this inquiry, the framework 105 notifies the service management program 107 that three service programs, namely, the HTTP service program 106, service management program 107, and position acquisition service program 108 are existing and all running.

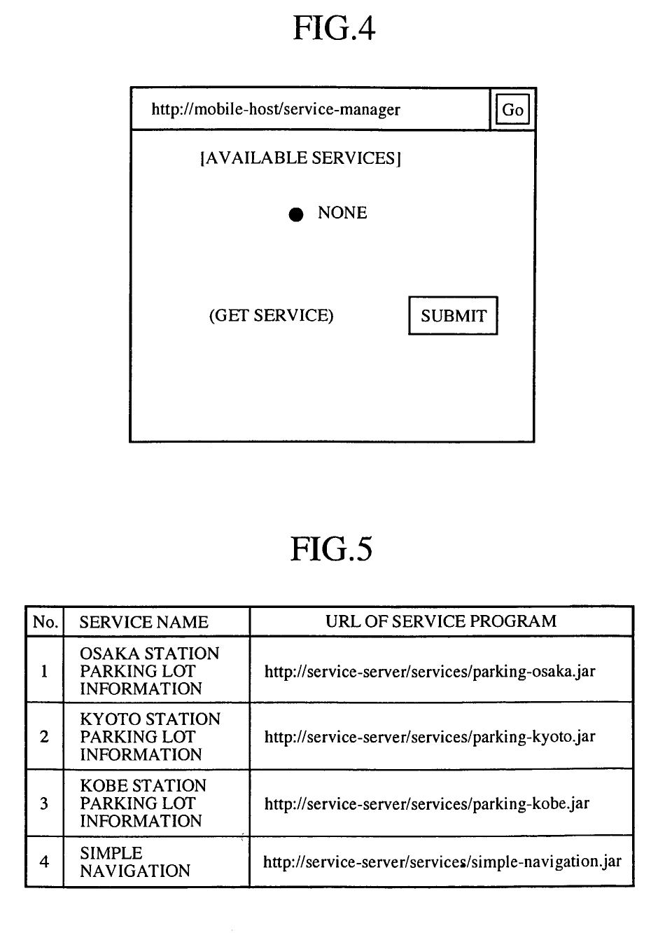

When the service management program 107 detects that no service program other than these three essential service programs is existing, it generates a service management screen image as shown in FIG. 4 described by HTML (Hyper Text Markup Language), and outputs HTML to the HTTP service program 106 as a response to the GET request.

The framework 105 has a capability of performing the dynamic start, stop, add, delete and the like of a service program, and managing the service program. The specific specification and operation of the framework 105 is complied with the specification of OSGi (Open Services Gateway Initiative).

OSGi is an industry trade group, which is endeavoring to promote the standardization and dispersion for technical specifications for connecting household electrical appliances to the Internet so as to mutually download services between personal computers and the household electrical appliances.

Definitions are given also to a service program running on a framework complied with the OSGi specification, and the service programs need to fulfill a form called bundle. The bundle form is given by compressing the three of a manifest (contents catalog) file, class files of the service program itself, and data necessary for operating the bundle in the form of JAR (Java Archive). In the manifest file, the class name making the entry point when activating the bundle should be manifested in text form, as shown by “Bundle-Activator: Service Manager.” Further, the service program is obliged to contain the Start ( ) method called from the framework at the time of start, and the Stop ( ) method called at the time of stop.

Then, at step ST3, the HTTP service program 106 sends the HTML created by the service management program 107 to the Web browser 202 as a response for the GET request.

The Web browser 202 interprets the HTML sent from the HTTP service program 106, generates a service management screen image as shown in FIG. 4, and displays it on the liquid crystal display 25 with touch panel of the PDA 22.

At step ST4, when the user looks at the service management screen image and sees that there is no available service, and pushes the execution button at the side of the display of “get service,” the Web browser 202 sends a POST request for HTTP containing the URL of the service management program 107 and a character string indicating that the execution button for “get service” is pushed to the HTTP service program 106.

When the HTTP service program 106 receives the POST request, it instructs the service management program 107 to response to the POST request, and indicates that the user's selection is “get service.” In this case, the doPost ( ) method of the service management program 107 is called.

As described above, when the user selects “get service,” then, at step ST5, the service management program 107 sends a GET request for HTTP through the HTTP service program 106 to get the service list 311 from the service downloading server 32.

Upon receipt of the GET request for HTTP, the Web server 303 on the service downloading server 32 searches the database 310, and transfers a file of the service list 311 as a response.

The service management program 107 receives the service list 311 through the HTTP service program 106. The service list 311 contains service names and the URLs of the service programs providing their capabilities, as shown in FIG. 5.

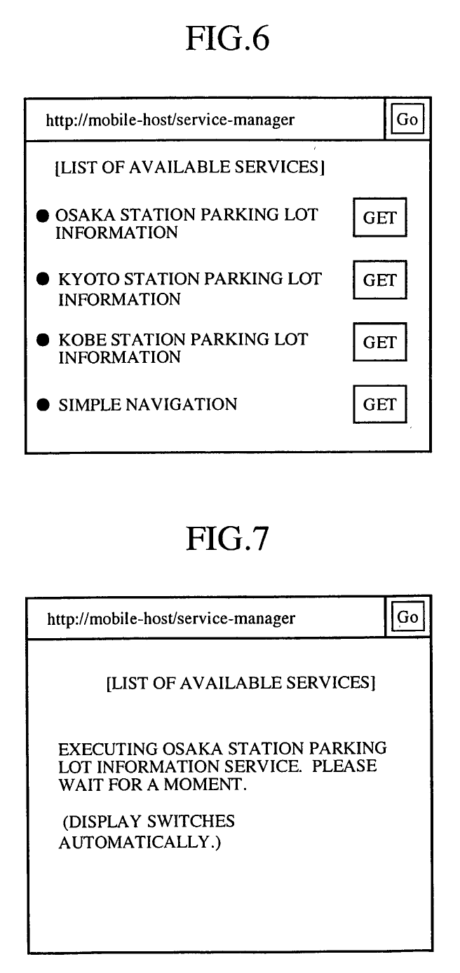

At step ST6, the service management program 107 generates a service selection screen image described by HTML as shown in FIG. 6 based on the service list 311 transmitted from the service downloading server 32, and transmits the HTML as a response to the POST request from the Web browser 202.

The Web browser 202 interprets the HTML sent from the HTTP service program 106, generates the service selection screen image as shown in FIG. 6, and displays it on the liquid crystal display 25 with touch panel on the PDA 22.

Then, at step ST7, if the user looks at the service selection screen image, and for instance, selects “Osaka Station parking lot information” and pushes the get button beside it, then, the Web browser 202 sends a POST request indicating that the user has selected “Osaka Station parking lot information” to the HTTP service program 106, as with step ST4.

When the HTTP service program 106 receives the POST request, it instructs the service management program 107 to respond to the POST request, and indicates that the user's selection is “Osaka Station parking lot information.”

At step ST7, if the user pushes the back button (not shown) of the Web browser 202, the process returns to step ST2 to generate the service management screen image again.

If the user selects “Osaka Station parking lot information,” then, at step ST8, the service management program 107 transmits a GET request for HTTP using the URL of an Osaka Station parking lot information service program 109, thereby getting the Osaka Station parking lot information service program 109 from the service downloading server 32.

When the Web server 302 receives the GET request, it searches the service program 312 in the database 310, transmits the bundle of the requested service program (here, the Osaka Station parking lot information service program 109) as a response, and the service management program 107 receives the bundle.

At step ST9, the service management program 107 adds the bundle of the received Osaka Station parking lot information service program 109 to the framework 105 in a manner complied with the OSGi specification.

Subsequently, the service management program 107 executes the added Osaka Station parking lot service program 109 in a manner complied with the OSGi specification.

And, the service management program 107 creates HTML as shown in FIG. 7 as a response to the POST request for HTTP received from the Web browser 202 at step ST7, or the POST request for HTTP indicating that the user has selected “Osaka Station parking lot information,” and transmits the HTML to the web browser 202. At this point, the following meta tag is added to the HTML.

Meta tag

<meta http-equiv=“Refresh” content

=“5;url=10.140.209.245/parking-oosaka”>

By using this meta tag, it is possible to jump to the linked destination (URL of the Osaka Station parking lot information service) indicated by the expression following “url=” in five seconds.

At step ST10, by the above meta tag, the Web browser 202 sends the GET request for HTTP to the Osaka Station parking lot information service program 109.

When the Osaka Station parking lot information service program 109 receives the GET request for HTTP, it requests the service downloading server 32 for the full/empty status of the parking lot by HTTP.

Whereupon, the service downloading server 32 searches the database 310, sends data indicative of the full/empty status of the Osaka Station parking lot from the service data 313 to the Osaka Station parking lot information service program 109 as a response. In addition, the data indicative of the full/empty status of the Osaka Station parking lot is received and always updated by the service downloading server 32. The volume of the data indicating the full/empty status of the Osaka Station parking lot is much smaller than that of the Osaka Station parking lot information service program 109.

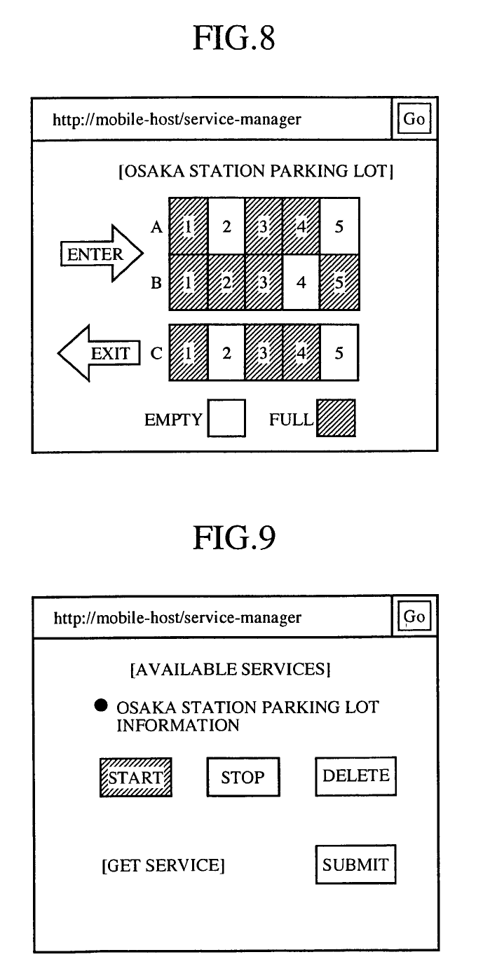

When the Osaka Station parking lot information service program 109 receives the service data 313 indicative of the full/empty status of the Osaka Station parking lot, it generates the screen image as shown in FIG. 8 showing the construction and full/empty status of the parking lot described by HTML based on the service data 313, and sends the HTML to the Web browser 202 as a response.

When the Web browser 202 receives the HTML from the Osaka Station parking lot information service program 109, it displays a screen image as shown in FIG. 8.

At step ST11, if the user pushes the back button of the Web browser 202, the process returns to step ST2 to display the service management screen image. If the user operates the service program, the Web browser 202 again generates the screen image of the Osaka Station parking lot information service program 109 at a fixed time interval, and the process returns to step ST10. As a technique for again displaying the screen image at a fixed time interval, the above meta tag may be used.

If the process returns to step ST2 after the Osaka Station parking lot information service program 109 has got, then, at step ST3, the service management screen image of FIG. 9 is displayed, and the process proceeds to step ST4. In FIG. 9, since the Osaka Station parking lot information service program 109 is already executed, the gray start buttons indicate that they are being disabled, and that the end and delete buttons are available to the contrary.

At step ST4, if the user looks at the service management screen image of FIG. 9 and pushes the end button, the process proceeds to step ST13 for ending service, and if the delete button is pushed, the process proceeds to step ST14 for deleting service. Although the start button is being disabled in FIG. 9, the process proceeds to step ST12 for starting service if this button is pushed.

That is, at step ST12 where the process starts a service, the service management program 107 activates the bundle of the service program (for instance, Osaka Station parking lot information service program 109) according to the OSGi specification. By invoking the Start ( ) method of a service program to be started, the framework 105 executes the service program.

At step ST13 where the process ends service, the service management program 107 stops the execution of the bundle of the service program according to the OSGi specification. By invoking the Stop ( ) method of a service program, the framework 105 stops the execution of the service program.

At step ST14 where the process deletes service, the framework 105 deletes the service program to be processed from the bundle management information according to the OSGi specification, and deletes the bundle of the service program stored in the RAM.

As obvious from the foregoing descriptions, according to the first embodiment, since the service downloading system has been configured as follows, i.e., a request for getting a service is sent to the service downloading server 32, a service program which offers the service is received from the service downloading server 32, and the service program is executed, it eliminates the need for collection of information each time the user wishes to download the service if the service program which offers the requested service is got once. Accordingly, this prevents the traffic from being cumulatively increased.

In addition, since the service program is not graphical data, the data volume is smaller than the traffic information consisted of graphical data. Further, by collecting service data of a data volume much smaller than that of the service program, the latest information may be displayed.

### Second Embodiment

While in the above first embodiment the service downloading system has shown in which the service list 311 made up of service names and the URLs of the service programs providing the their capabilities is provided to the mobile information unit 13, the service list 311 showing available services hierarchized by, for instance, category may be provided to the mobile information unit 13.

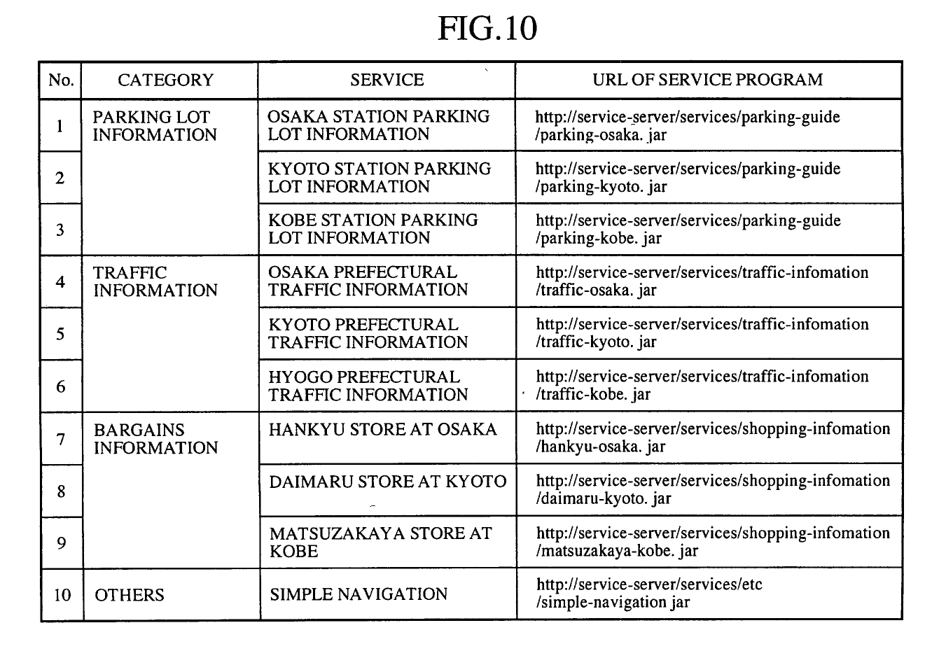

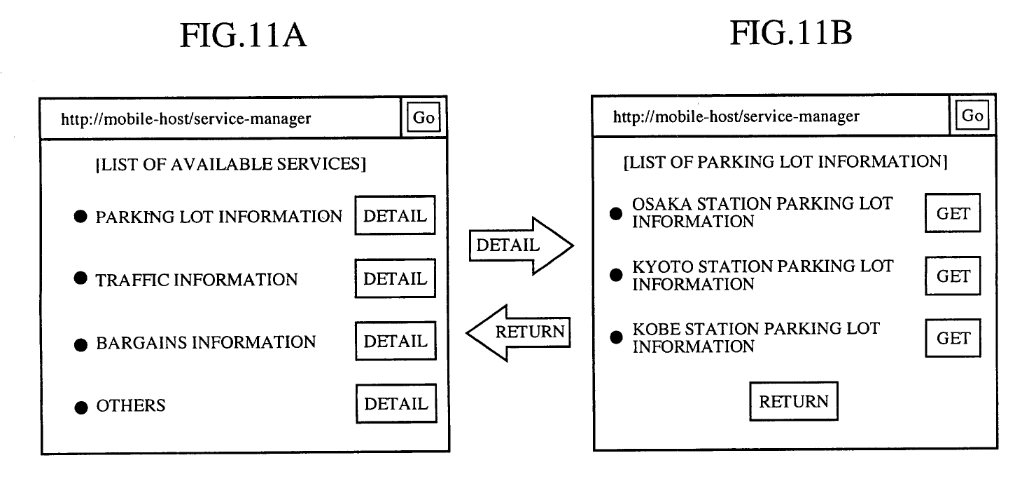

FIG. 10 is an explanatory diagram showing the service list 311 hierarchizedby category, and FIG. 11 is an explanatory diagram showing an example of the service selection screen image generated at step ST6 in FIG. 3.

Now, the operation of the service downloading system of the second embodiment will be described.

In the second embodiment, at step ST6, the service management program 107 gets the service list 311 as shown in FIG. 10 from the service downloading server 32, and generates the service selection screen image as shown in FIG. 11 based on the service list 311.

If the user pushes the detail button beside “Parking lot information” in the screen image of FIG. 11A, the service management program 107 generates the screen image of FIG. 11B. If the user pushes the back button in the screen image of FIG. 11B, the service management program 107 generates the screen image of FIG. 11A.

When the user pushes the detail button beside “Traffic information,” “Bargains information,” or “Others,” the service management program 107 generates a screen image similar to FIG. 11B for each category based on the service list 311 shown in FIG. 10.

According to the second embodiment, since services are categorized by category, the user can easily select any service, which improves the ease of use.

### Third Embodiment

While in the above first and second embodiments the service downloading systems have shown in which any service is selected from the services shown in the service list 311, and a request for getting the service is sent to the service downloading server 32, it is also possible that the mobile information unit 13 sends positional information indicative of its current position to the service downloading server 32 when sending the request for getting the service to the service downloading server 32, and the service downloading server 32 selects available services in accordance with the positional information and downloads the service list 311 showing those services to the mobile information unit 13.

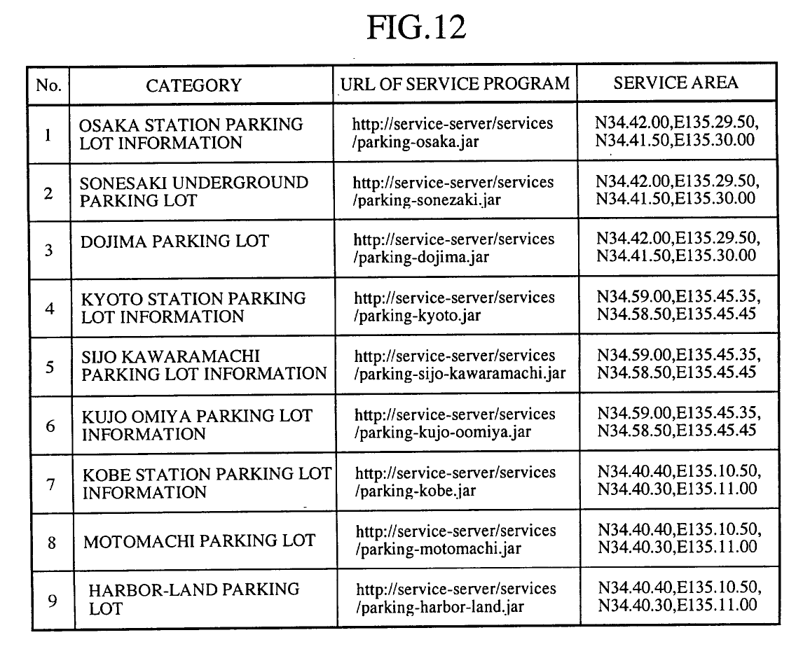

FIG. 12 is an explanatory diagram showing the service list 311 containing therein information on the area within which service can be available. The character strings appeared in the service area column represent the latitude and longitude of the upper-left side of the service area, and the latitude and longitude of the lower-right side of the service area, respectively.

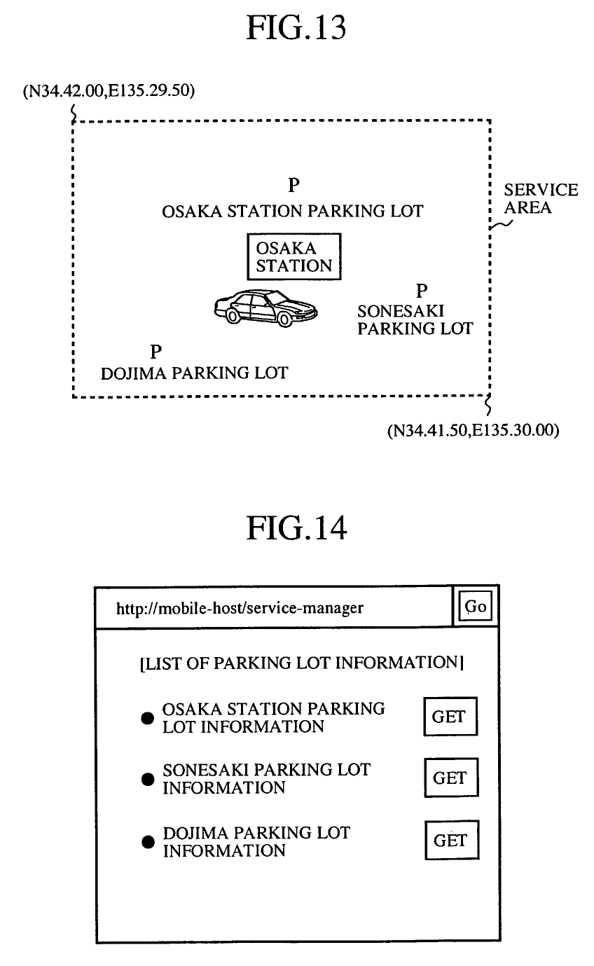

FIG. 13 is a schematic diagram showing the relationship between the vehicle position and the service area, and shows that, if the vehicle is existing within the range of a dotted rectangle representing the service area, three parking lot information services can be available (FIG. 13 is an example in which three parking lots are available in the neighborhood of Osaka Station).

FIG. 14 is an explanatory diagram showing an example of the service selection screen image generated at step ST6 in FIG. 3, showing only the available services near the vehicle position.

The operation of the service downloading system of the third embodiment will be described.

In the third embodiment, when the service management program 107 gets the service list 311 shown in FIG. 12 from the service downloading server 32 at step ST6, it transmits a GET request for HTTP to the position acquisition service program 108 to get the vehicle position.

When the position acquisition service program 108 receives the GET request for HTTP, it gets the measured result of the position and direction by the GPS receiver 12 through the serial port 15 at an interval of, for instance, one second, and stores the measured result as a vehicle position and direction.

Here, the output of GPS receiver 12 is a character string such as “N35.10.20, E135.10.20” indicative of latitude and longitude, which reads 35 degrees 10 minutes 20 seconds of north latitude, and 135 degrees 10 minutes 20 seconds of east longitude.

When the position acquisition service program 108 receives the GET request from the service management program 107, it pads the stored vehicle position in HTML, and transmits the HTML to the service management program 107 as a response.

When the service management program 107 receives the HTML from the position acquisition service program 108, it extracts the character string representing the vehicle position and recognizes the latitude and longitude.

The service management program 107 compares the latitude and longitude of the vehicle position with the service area shown in the service list 311, and if the vehicle position is within the service area, it selects the service as an available one and generates a service selection screen image as shown in FIG. 14.

According to the third embodiment, since the user can recognize available services at the current position, it allows easy selection of a service,

Further, since unavailable services at the current position can be removed from the service list, it reduces the traffic.

In addition, if the vehicle position is out of the service area, the service management program 107 may delete unavailable service programs. In this case, unavailable services can be prevented from being presented to the user, which leads to a saving of the RAM in the mobile information unit 13.

Further, previous addition of the facility locations of the parking lots or the like to the service list 311 enables to show facilities in ascending order by the distance between facility location and vehicle position when the service management program 107 displays the service selection screen image.

### Fourth Embodiment

While the above first to third embodiments the service downloading systems have shown in which one service downloading server 32 is provided, a plurality of service downloading servers 32 maybe provided for the respective areas.

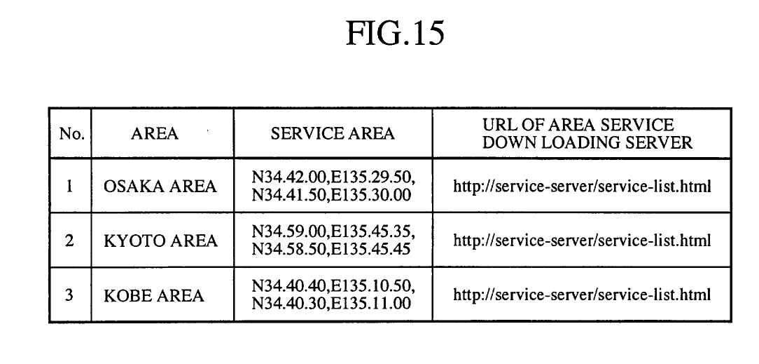

FIG. 15 is an explanatory diagram showing the service list 311 containing therein service areas and the URLs of the area service downloading servers in the areas.

The service management program 107 compares the vehicle position with the service areas in the service list 311, and gets the service list 311 from the service downloading server 32 named by the URL corresponding to the vehicle position.

According to the fourth embodiment, user's accesses can be prevented from centering on a particular service downloading server 32, and the load imposed by user accesses can be distributed among a plurality of service downloading servers 32, so steady service downloading can be provided to users.

### Fifth Embodiment

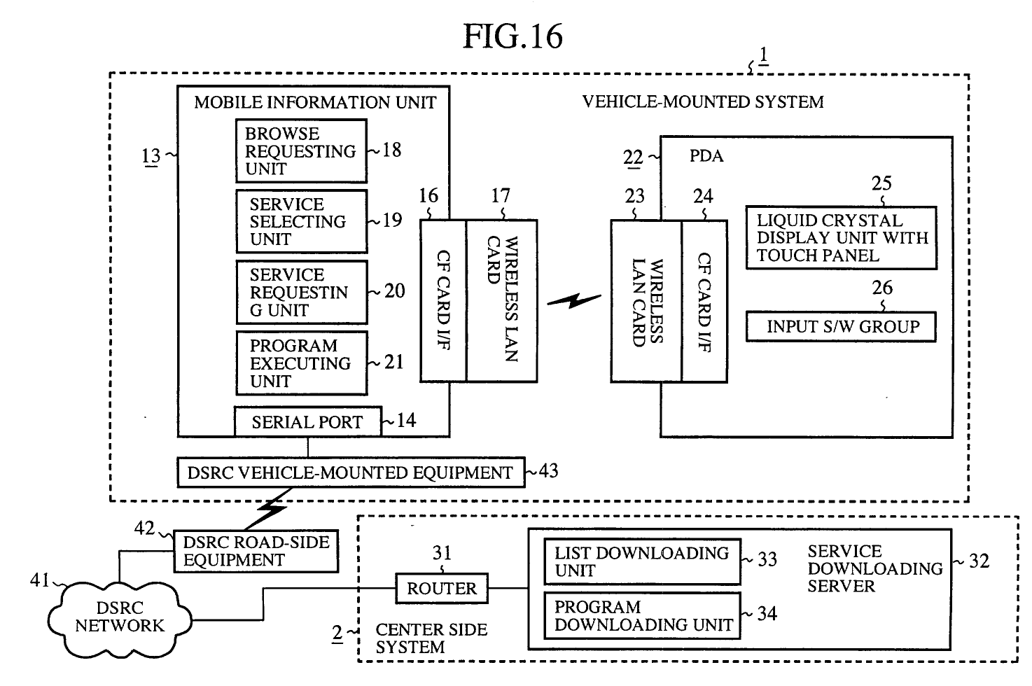

FIG. 16 is a block diagram showing the service downloading system according to the fifth embodiment of the present invention, and in FIG. 16, like reference numerals as FIG. 1 indicate the same or identical components, and therefore the description thereof is omitted for brevity's sake.

Reference numeral 41 denotes a DSRC network which is a communication network based on the DSRC (Dedicated Short Range Communication) system, reference numeral 42 a DSRC road-side equipment (Dedicated Short Range Communication unit) placed on the road side or the like, and reference numeral 43 a DSRC vehicle-mounted equipment (Dedicated Short Range Communication unit) placed in the room of a vehicle or the like.

The DSRC system adopts the same communication system as ETC (Electronic Toll Collection: automated toll collection) (frequency: 5.8 GHz band), and when the vehicle passes within the communication area of the DSRC road-side equipment 42 placed on the road side, communication is performed between the DSRC vehicle-mounted equipment 43 mounted on the vehicle and the DSRC road-side equipment 42.

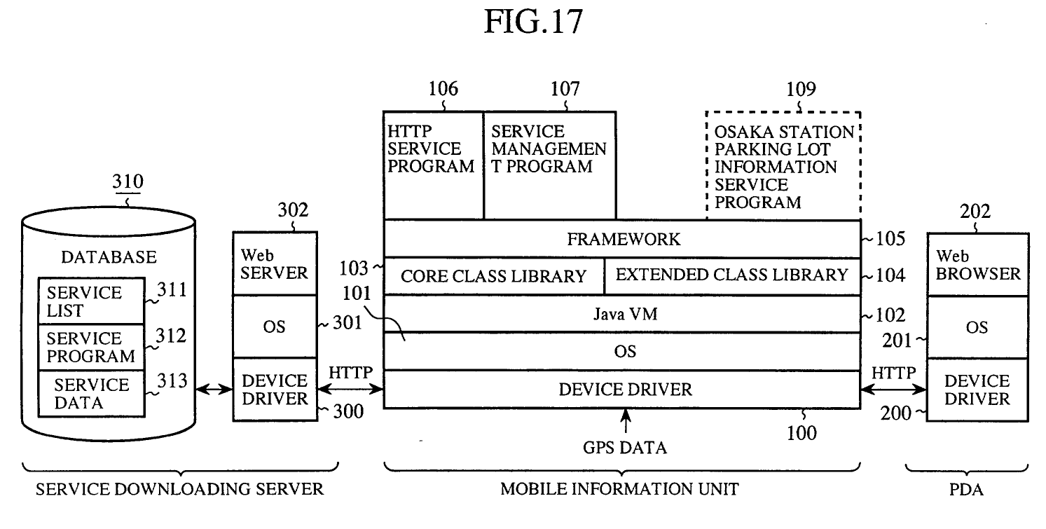

FIG. 17 is a software block diagram showing the software configuration of the service downloading system according to the fifth embodiment, and it is similar to FIG. 2 except for the point that the position acquisition service program 108 for gaining GPS data is deleted.

Now, the operation of the service downloading system of the fifth embodiment will be described.

When the user selects “get service” in a manner similar to the above first embodiment, then, at step ST5, the service management program 107 sends a GET request for HTTP to get the service list 311 from the service downloading server 32.

The GET request sent from the service management program 107 is transmitted from the DSRC vehicle-mounted equipment 43, and at this point of time, the DSRC road-side equipment 42 covering the vehicle position receives the GET request. The DSRC road-side equipment 42 transmits the identification number of itself and the GET request to the service downloading server 32 via the DSRC network 41.

When the service downloading server 32 receives the GET request transmitted from the DSRC road-side equipment 42, it checks the identification number of the DSRC road-side equipment 42 transmitted together with the GET request, and sends the service list 311 corresponding to the identification number as a response. Since the DSRC road-side equipment 42 is placed fixed, the identification number of the DSRC road-side equipment 42 equivalents to the service area in FIG. 12.

The DSRC road-side equipment 42 transmits the service list 311 sent from the service downloading server 32 to the DSRC vehicle-mounted equipment 43. The subsequent procedure follows the same steps as the above first embodiment.

According to the second embodiment, since the user can get the service corresponding to the vehicle position only by passing through the communication area of the DSRC vehicle-mounted equipment 43 without attaching the GPS receiver 12 on the mobile information unit 13, the cost of the mobile information unit 13 can be reduced.

Further, as a result of the removal of unavailable services at the current position from the service list, it reduces the traffic.

### Sixth Embodiment

Although no specific reference has been made in the above first to fifth embodiments, the program executing unit 21 may act as simple navigation. That is, a service program may be executed for getting the background map image of the area containing the current position of a vehicle, and displaying the vehicle image while superposing it on the current position of the vehicle in the background map image

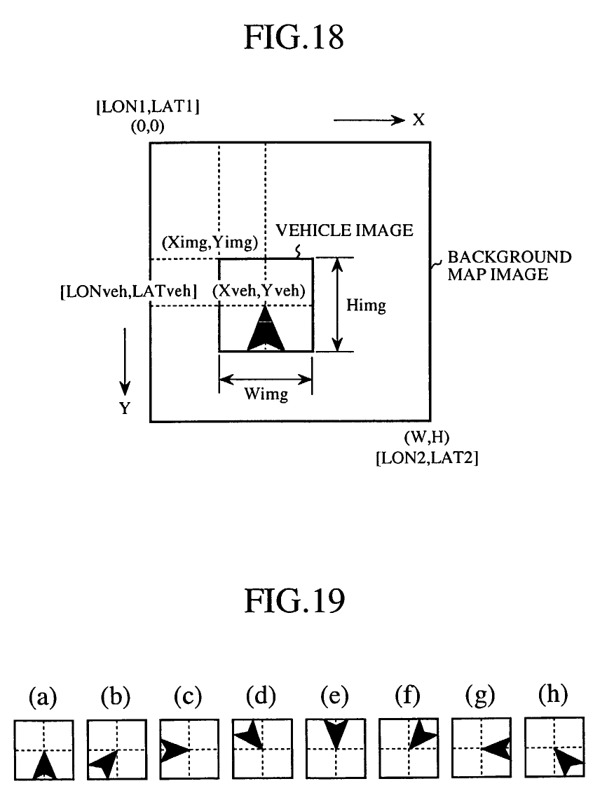

FIG. 18 is a schematic diagram for explaining a method in which a vehicle image indicating the position and direction of a vehicle is superposed on a background map image showing the map forming the background, thereby implementing the simple navigation.

The background map image is a collection of color graphics showing topographical features, buildings, roads and the like, and displayed in an image format such as GIF (Graphics Interchange Format), JPEG (Joint Photographic Coding Experts Group), PNG (Portable Network Graphics), or the like which are common in the Internet. The vehicle image is displayed in a similar image format, the position and direction of the vehicle is displayed, for instance, by an arrow feather mark of an opaque color, and the remaining background displayed by a transparent color, whereby the background map image is made transparent even in superposition.

In FIG. 18, the coordinate system for image display is defined as follows.

Hereupon, letting the upper-left end of the background map image to be the origin, and the rightward direction from the origin to be X-direction, while the direction from the downward direction from the origin to be Y-direction. Moreover, letting the width and height of the background map image to be W dots and H dots, respectively, after making the width and height of the background map image match the width and height of the liquid crystal display 25 with touch panel of the PDA 22, the coordinates of the upper-left end of the map image are (0, 0), and the coordinates of the lower-right end are (W, H).

The tip of the arrow feather in the vehicle image represents the vehicle position, and the direction of the arrow feather represents the vehicle direction. The vehicle position is made match the center of the vehicle image, and let its coordinates to be (Xveh, Yveh), and the coordinates of the upper-left end of the vehicle image to be (Ximg, Yimg). Further, let the width of the vehicle image to be Wimg, and its height to be Himg.

The display range of a map and the vehicle position are often expressed by latitude and longitude, and to implement the simple navigation capability, the latitude and longitude should be corresponded to the display coordinate system. It is assumed that the representative points designating the display range of the map are the upper-left point and lower-right ends of the map, and their coordinates in latitude and longitude are [LON1, LAT1] and [LON2, LAT2],respectively. Further, the coordinates of the vehicle position in latitude and longitude are [LONveh, LATveh].

The coordinates in latitude and longitude [LON1, LAT1] correspond to the display coordinates (0, 0), [LON2, lAT2] to (W, H), and [LONveh, LATveh] to (Xveh, Yveh).

To convert the vehicle position [LONveh, LATveh] in latitude and longitude to the display coordinates (Xveh, Yveh), the following conversion equations may be used.

Conversion Equations

Xveh=W×(LONveh−LON1)/(LON2−LON1) (1)

Yveh=H×(LAT1−LATveh)/(LAT1−LAT2) (2)

To display background map image on the background of HTML, a <BODFY>tag may be specified as follows.

<BODY>Tag

<BODY background=“mobile-host/images/map.jpg”>

To display the vehicle position on the background map image in superposition, the <IMG>tag of HTML may be specified as follows.

<IMG>tag

<P><IMG>src=“(URL of vehicle image)” border=“0” width=“(width of vehicle image)” height=“(height of vehicle image)” hspace=“(number of horizontal space dots)” vspace=“(number of vertical space dots)”></P>

Here, mobile-host/images/vehicle.jpg is specified as (URL of vehicle image), a character string representing the value of Wimg as (width of vehicle image), a character string representing the value of Himg as (height of vehicle image), a character string representing the value of Ximg as (number of horizontal space dots), and a character string representing the value of Yimg as (number of vertical space dots).

As to the vehicle position, (number of horizontal space dots) and (number of vertical space dots) are specified. The value of Ximg and the value of Yimg can be calculated by the following equations by using Xveh and Wimg, and Yveh and Himg, respectively.

Ximg=Xveh−Wimg/2 (3)

Yimg=Yveh−Himg/2 (4)

As to the vehicle direction, it is only needed to create a plurality of vehicle images as shown in FIG. 19, and select and display an appropriate vehicle image in accordance with the measured vehicle direction.

Now, the operation of the service downloading system of the sixth embodiment will be described.

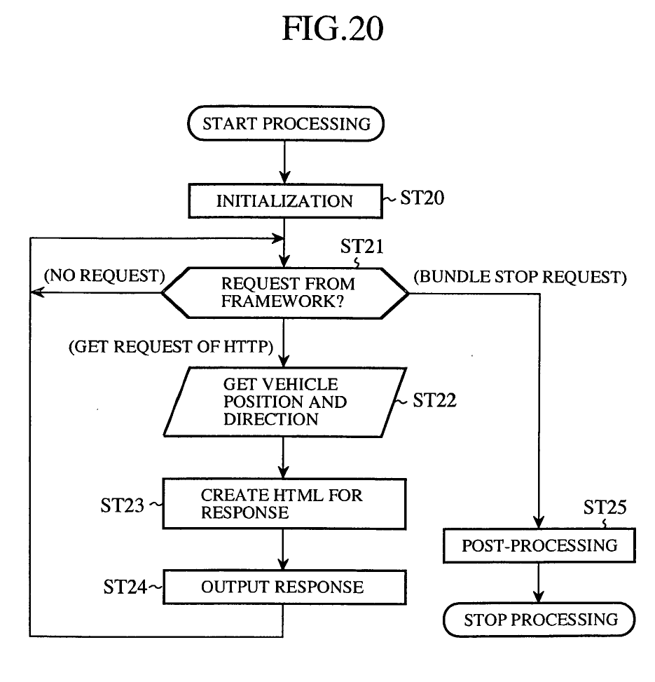

FIG. 20 is a flowchart showing the procedures of the service program providing the simple navigation capability (hereinafter referred to as simple navigation service program).

The simple navigation service program runs on the framework 105 complied with OSGi, as does the parking lot information service program 109.

First, at step ST20, the framework 105 invokes the Start ( ) method of the simple navigation service program to activate the bundle. Initialization of the variables of the simple navigation service program and the like are performed to get ready for the operation.

At step ST21, the simple navigation service program waits for the request from the framework 105, and the process branches in response to the request. The process returns to step ST21 to repeatedly wait for a request if there is no request, and proceeds to step ST22 if there is a GET request for HTTP, and to step ST25 if there is a bundle stop request.

At step ST22, the framework 105 invokes the doGet ( ) method of the simple navigation program, and the simple navigation program gets the vehicle position and direction from the position acquisition service program 108 in a manner similar to the above third embodiment. Although the vehicle direction has not described in the above third embodiment, it is possible that, for instance, the due north is set zero degree, and the vehicle position is expressed by numbers from 0 to 360 degrees, clockwise from the due north.

Then, at step ST23, the simple navigation service program compares the vehicle position with the range of the background map image previously stored in the bundle.

If the vehicle position is within the range of the background map image, the simple navigation service program uses the already mentioned method to generate HTML for superposing the background map image and the vehicle image, and if the vehicle position is not within the background map image, it generates HTML for displaying that the vehicle position is out of the range of the background map image.

Further, if the vehicle position is within the range of the background map image, the simple navigation service program appropriately selects a vehicle image to be superposed from the eight vehicle images shown in FIG. 19 in accordance with the vehicle direction. The vehicle images are also previously stored in the bundle.

Here, the eight images in FIG. 19 are images expressing 360 degrees by eight directions, and (a) represents that numbers equal to or larger than 0 degree and equal to or smaller than 22.5 degrees and numbers exceeding 337.5 degrees and smaller than 360 degrees are expressed by 0 degree, (b) represents that numbers exceeding 22.5 degrees and equal to or smaller than 67.5 degrees are expressed by 45 degrees, (c) represents that numbers exceeding 67.5 degrees and equal to and smaller than 112.5 degrees are expressed by 90 degrees, (d) represents that numbers exceeding 112.5 degrees and equal to or smaller than 157.5 degrees are expressed by 135 degrees, (e) represents that numbers exceeding 157.5 degrees and equal to or smaller than 202.5 degrees are expressed by 180 degrees, (f) represents that numbers exceeding 202.5 degrees and equal to or smaller than 247.5 degrees are expressed by 225 degrees, (g) represents that numbers exceeding 247.5 degrees and equal to or smaller than 292.5 degrees are expressed by 270 degrees, and (h) represents that numbers exceeding 292.5 and equal to or smaller than 337.5 degrees are expressed by 315 degrees. At step ST24, the HTML generated at step ST23 is outputted to the HTTP service program 106, and the process returns to step ST21 to wait for the request from the framework 105.

If a bundle stop request is made, then at step ST25, the framework 105 invokes the Stop ( ) method of the simple navigation service program, and the simple navigation service program performs post-processing such as destruction of the reference of the internally generated object, and stops the process.

According to the sixth embodiment, the vehicle position can visually be checked on the map by a simple method without relying on the expensive car navigation unit.

### Seventh Embodiment

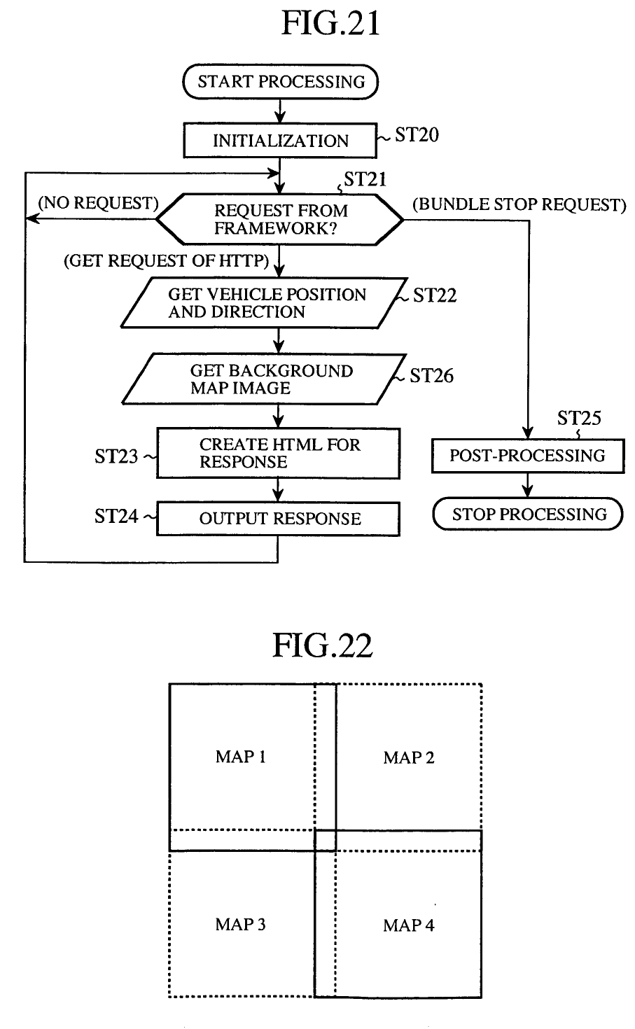

While in the above sixth embodiment the service downloading system has shown in which the background map image and the vehicle image are stored in the bundle of the simple navigation service program, the background map image may be get from the service downloading server 32, as shown at step ST26 in FIG. 21.

At step ST26, the simple navigation service program sends a POST request for HTTP containing the vehicle position to the Web server 302 of the service downloading server 32 to get the background map image containing the vehicle position.

When the Web server 302 receives the POST request for HTTP containing the vehicle position, it compares the vehicle position contained in the POST request with the plurality of background map images stored in the service data 313 to select the background map image containing the vehicle position, and returns the background map image to the simple navigation service program as a response. The other procedure follows the same steps as the sixth embodiment, and therefore the description thereof is omitted for brevity's sake.

According to the seventh embodiment, if many background map images are provided in the service downloading server 32, service can be rendered in a wide areas, and the RAM area of the mobile information unit 13 can be made small.

FIG. 22 is an explanatory diagram showing an example in which four adjacent background map images are partly overlapped with each other. In FIG. 22, if the service downloading system determines whether which center of the background map image is closest to the vehicle position and selects the closest one, then, the vehicle position can be refrained from being displayed at a position very close to the border of the background map image, which makes the vehicle position easy to see.

### Eighth Embodiment

While in the above first to seventh embodiments the service downloading systems have shown in which HTML is used as a markup language, other markup languages, for instance, XML (extensible Markup Language), SGML (Standard Generalized Markup Language), and the like may be used.

Besides, while in the above first to seventh embodiments the framework have shown complied with the OSGi specification, it is only needed to dynamically start, stop, add, and delete the service program, so it may be complied with specifications other than the OSGi.

In addition, while in the above first to seventh embodiments the service downloading systems have shown in which the Java language is used as the programming language for describing the framework and service programs, other programming languages such as the C++ language and the C# language may be used.

Further, although in the above third embodiment the service downloading system has shown in which the service management program 107 determines whether the mobile information unit is in the inside or the outside of the service area, the service program downloaded from the service downloading server 32 may be determined by itself, or by the position acquisition service program 108.

Furthermore, although in The above first to seventh embodiments the service downloading systems have shown in which HTTP is used as the communication protocol between the mobile information unit 13 and the service downloading server 32, and the Web server 302 is used, but FTP (File Transfer Protocol) may be used as the communication protocol, with a FTP server being used in place of the Web server 302.

What is claimed is:

1. A mobile information unit comprising:
browse requesting means for sending a request for browsing available services to a service downloading server, and receiving a service list showing available services from the service downloading server;
service selecting means for selecting any service from the services shown in the service list received by said browse requesting means;
service requesting means for sending a request for getting the service selected by said service selecting means to said service downloading server, and receiving a service program which offers said service from the service downloading server; and
service executing means for executing the service program received by said service requesting means.

2. The mobile information unit according to claim 1, wherein the browse requesting means sends positional information indicative of the current position to said service downloading server when sending the request for browsing available services to the service downloading server.

3. The mobile information unit according to claim 1, wherein the browse requesting means uses dedicated short range communication to send the request for browsing available services to the service downloading server.

4. The mobile information unit according to claim 1, wherein the program executing means displays the executed result of a service program on the display of an external information unit.

5. The mobile information unit according to claim 1, wherein the program executing means executes a service program for getting the background map image of an area containing the current vehicle position, and displaying the vehicle image while superposing it on the current vehicle position in the background map image.

6. A service downloading server comprising:
list downloading means for downloading a service list showing available services to a mobile information unit when it receives a request for browsing available services from said mobile information unit;
program downloading means for downloading a service program which offers a service shown in said service list to said mobile information unit when it receives the request for getting the service from said mobile information unit.

7. The service downloading server according to claim 6, wherein the list downloading means downloads a service list, in which available services are hierarchically arranged, to the mobile information unit.

8. The service downloading server according to claim 6, wherein, upon receipt of positional information indicative of the current position from the mobile information unit, the list downloading means selects available services in accordance with the positional information, and downloads a service list showing the services to the mobile information unit.

9. The service downloading server according to claim 6, wherein, when the list downloading means uses a dedicated short range communication unit to download a service list to the mobile information unit, it downloads a service list showing available services within the communication area of the dedicated short range communication unit to the mobile information unit.

10. A service downloading system comprising:
a service downloading server for downloading a service list showing available services upon receipt of a request for browsing the available services, and a service program which offers a service shown in the service list upon receipt of a request for getting the service; and
a mobile information unit for sending a request for browsing available services to said service downloading server and receiving a service list from the service downloading server, for selecting any service among the services shown in the service list and sending a request for getting the service to said service downloading server, and for receiving a service program which offers said service from the service downloading server and executing the service program.
